(19) United States
(12) Patent Application Publication
(10) Pub. No.: US 2026/0189009 A1
(43) Pub. Date: Jul. 2, 2026

(54) TEMPERATURE-BASED CONTROL OF BATTERY HEATING AND LOAD ACTIVATION

(71) Applicant: FORD GLOBAL TECHNOLOGIES, LLC, Dearborn, MI (US)

(72) Inventors: Haider MHIESAN, Canton, MI (US); Timothy HARRIS, Grosse Ile, MI (US); Kirk PULAY, Belleville, MI (US); Christopher Bernard TROMBETTA, Commerce Township, MI (US)

(21) Appl. No.: 19/360,232

(22) Filed: Oct. 16, 2025

Related U.S. Application Data
(60) Provisional application No. 63/739,890, filed on Dec. 30, 2024.

(51) Int. Cl. H02J 3/14; B60L 55/00; H01M 10/615; H01M 10/635; H02J 3/00; H02J 3/32; H02J 3/40

(52) U.S. Cl. CPC H02J 3/17; B60L 55/00; H01M 10/615; H01M 10/635; H02J 3/004; H02J 3/32; H02J 3/40; H02J 2105/12; H02J 2105/51; H02J 2105/54; H02J 2207/10

(57) ABSTRACT

A home energy system includes a controller, a standby battery that energizes the controller during a grid loss condition, and a heating element thermally coupled to the standby battery. When a sensed temperature is below a cold threshold, the controller operates the heating element to apply thermal energy to the standby battery and, upon a new load request, adjusts power to the heating element to reduce active load demand. When the sensed temperature is above a hot threshold, the controller adjusts a state of a controllable switch to reduce active load demand.

### CROSS-REFERENCE TO RELATED APPLICATION

This application claims the benefit of U.S. provisional application Ser. No. 63/739,980, filed Dec. 30, 2024, the disclosure of which is hereby incorporated in its entirety by reference herein.

### TECHNICAL FIELD

This disclosure relates to energy management systems, and more particularly to control of electrical resources in such systems.

### BACKGROUND

Residential energy systems may coordinate power delivery from utility grids and backup sources.

### SUMMARY

A home energy system includes a controller, a standby battery that energizes the controller during a grid loss condition, and a heating element thermally coupled to the standby battery. When a sensed temperature falls below a cold threshold, the controller may operate the heating element to apply thermal energy to the standby battery and, upon a new load request, adjust power to the heating element—such as by varying a pulse-width modulation duty cycle—to reduce active load demand. If additional reduction is required, the controller may suspend operation of the heating element altogether. When the sensed temperature exceeds a hot threshold, the controller may adjust the state of a controllable switch to reduce active load demand, for example by disconnecting at least one load, with the possibility of reconnecting that load after the temperature falls back below the hot threshold. The cold and hot thresholds may correspond to temperature ranges such as about 0° C. to about 15° C. and about 40° C. to about 60° C., respectively. In some embodiments, the standby battery may also energize an inverter that establishes an alternating-current reference during grid loss, such as an inverter within electric vehicle supply equipment (EVSE). The EVSE may in turn activate relays of an electric vehicle to enable bidirectional power flow between the vehicle and the home energy system when the grid is unavailable.

A controller for a home energy system includes processing hardware and memory with instructions executable to manage heating of a standby battery during cold operating conditions. When a sensed temperature at the standby battery falls below a cold threshold, the controller may activate a heating element thermally coupled to the battery. During such a condition, if a new load request arises, the controller can adjust power delivered to the heating element—such as by varying a pulse-width modulation duty cycle—to preserve capacity for the requested load. If the available margin remains insufficient after this adjustment, the controller may suspend heater operation to allow the new load to be activated. The cold threshold may correspond to a sensed temperature in the range of about 0° C. to about 15° C., as measured by a sensor proximate to the standby battery, and the controller may resume heater operation once margin for the new load is restored.

A method of operating a home energy system involves managing standby battery heating during cold conditions while balancing new load requests against available system capacity. The heating element thermally coupled to the standby battery may be operated at a baseline power level when the sensed temperature is below a cold threshold. Upon receipt of a new load request that exceeds available system capacity, the method may reduce power to the heating element, such as by adjusting its pulse width modulation duty cycle, to free capacity. If capacity remains insufficient, the method may proceed by disconnecting a home load, and, if still insufficient, by suspending heater operation, for example by temporarily deactivating the heating element before reactivating it when capacity recovers. Forecasting techniques may be applied using environmental sensor data and operating states of distributed energy resources, such as photovoltaic, battery, or electric vehicle inverters, to anticipate capacity conditions. In some cases, the standby battery also supplies power to electric vehicle supply equipment during the cold condition, with the new load request originating from that equipment in communication with a coupled electric vehicle.

### BRIEF DESCRIPTION OF THE DRAWINGS

FIG. 1 is a schematic diagram of a home energy management system (HEMS) showing interconnections among distributed energy resources, grid, loads, sensors, and controller components.

FIG. 2 is a flowchart illustrating a method of system operation in which cold-and hot-condition routines are executed based on monitored temperature thresholds.

FIG. 3 is a flowchart illustrating a method of managing battery heater operation and new load activation under cold-weather conditions.

FIG. 4 is a set of traces illustrating example system responses over time, including temperature, heater operation, new load margin, and new load activation state.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A home energy system may be configured to incorporate multiple sources and control elements to support residential power needs. A system may include a connection to the utility grid, distribution panels supplying local loads, and distributed energy resources (DERs) that generate or store electricity on-site. Such DERs can include photovoltaic systems, stationary battery units, combustion-driven generators, or electric vehicles capable of bidirectional power exchange.

To coordinate these components, a supervisory arrangement may be utilized to manage the routing of energy, the timing of source activation, and the sequencing of transitions between different operating states. This coordination may be implemented through a centralized controller, a distributed arrangement of control units, or a combination thereof.

A home energy management system (HEMS) provides an example of such supervisory control. A HEMS may incorporate switching devices, conversion stages, and communication interfaces to manage interaction between the grid, local loads, and DERs. It may further include logic to detect the availability of grid power and to orchestrate transitions into or out of grid-independent operation.

During normal conditions, the utility grid typically provides the primary source of electrical power to the residence. In this state, DERs may contribute in parallel with grid supply or may remain in standby, depending on configuration. For instance, a photovoltaic inverter may export supplemental energy while grid voltage is present, while a standby generator remains idle until specifically called upon.

When the utility grid becomes unavailable, the home energy system may operate in an isolated mode relying on local sources. In this case, the HEMS may initiate control sequences to disconnect from the grid, establish an internal voltage reference, and activate selected DERs that are capable of contributing power under off-grid conditions.

Grid-following devices, such as most photovoltaic inverters, typically require an external reference waveform to synchronize their output. These devices may suspend operation when the grid reference is lost. Grid-forming devices, such as a generator or a suitably configured inverter, can provide the necessary voltage and frequency reference for continued operation. Once such a reference is established, additional DERs may resume participation under HEMS coordination.

Within this broader framework, a standby battery may be used to power auxiliary functions of the HEMS, such as maintaining communication links, energizing relay coils, or supporting low-voltage electronics. In some implementations, the standby battery also supports startup sequences that prepare the system for vehicle-to-home or photovoltaic-to-home operation.

In colder environments, the standby battery may require heating to sustain its operating temperature. A heating element coupled to the standby battery can maintain a threshold temperature for reliable function. The current drawn by such a heating element, however, becomes part of the HEMS load during grid-disconnected operation and can represent a significant fraction of the available reserve.

In warmer environments, elevated ambient temperature can decrease the efficiency of electronic components and increase resistive losses in actuators such as relay coils. These effects raise the effective power draw of the system and can restrict its usable margin during high-temperature operation.

A HEMS controller may therefore be utilized to evaluate environmental conditions and make corresponding adjustments to its operation. In some cases, this includes monitoring ambient or component-level temperature, forecasting expected power consumption, and reallocating available resources among competing demands.

The system architecture often includes multiple distributed sources operating concurrently. For example, an electric vehicle connected via bidirectional supply equipment, a stationary storage unit, and a photovoltaic inverter may all contribute or draw power at different times. Each source or load adds complexity to the overall power management challenge, particularly when multiple relays are energized and the microcontroller performs intensive communication and processing tasks.

The coordination logic implemented in the HEMS controller may be configured to prioritize certain functions. Communication with a vehicle, for instance, may take precedence over illumination of indicator lights. Relay operation to establish a power path may be ranked above non-critical background tasks. Such prioritization requires a control scheme capable of forecasting demand and managing consumption dynamically.

In some arrangements, predictive models may be integrated into the controller to anticipate upcoming demand. These models can incorporate environmental input, recognize the current operational mode, and calculate an expected power profile. By forecasting load conditions rather than reacting only after demand arises, the controller can proactively allocate capacity and prevent interruptions.

Cold environments present a particular sequence of decisions for the controller. If the forecast indicates that available power is sufficient, the standby battery heater may continue at its nominal duty cycle. If capacity becomes constrained, the controller may reduce the heater's duty cycle through pulse width modulation. Should demand continue to exceed available resources, the controller may temporarily deactivate one or more non-critical components, or even interrupt the heater itself for a defined interval, before resuming normal operation.

In warm environments, the logic may instead reduce the number of active non-essential components or scale back microcontroller-intensive processes when operating near a thermal threshold. These measures reduce the load on the system and mitigate further heat accumulation.

The hardware involved may include a standby battery, a heating element, relays, sensors, and a controller arranged within an enclosure. Such systems are generally assembled with batteries positioned in compartments, relays mounted on circuit boards, sensors located near monitored components, and the controller programmed to carry out monitoring and control routines.

In the event of a grid outage, the standby battery may be the only immediate power source available to activate relays and establish communication with a vehicle battery or another distributed source. The way in which the standby battery's own heater is managed influences whether further resources can be brought online. At the same time, coordination of distributed sources under high-temperature conditions ensures that the system does not exceed the operating range of its electronic components. Temporarily deactivating non-essential tasks can maintain controller stability and preserve the operation of critical pathways such as vehicle-to-home power transfer. These dynamics illustrate that both cold and hot environmental conditions influence the control logic of the HEMS.

The configuration described herein provides a way for a home energy management system to adapt its power consumption to environmental conditions and system activity. Generally, the system integrates a standby battery, heating element, relays, and a controller programmed with predictive logic. The standby battery may power the electric vehicle supply equipment, activate relays, and maintain low-voltage functions during a grid outage. The controller monitors temperature and other system data, forecasts anticipated demand, and selectively scales or defers component activity to match available capacity.

The approaches described herein address various environmental scenarios. During cold conditions, the standby battery heater may consume a significant portion of available energy. The controller reduces the heater's duty cycle through pulse-width modulation when demand begins to exceed available capacity. If that step is insufficient, the controller may temporarily deactivate non-essential components, such as indicators, or suspend the heater itself for a brief interval before restoring operation.

During hot conditions, component efficiency may degrade and overall consumption may rise. In this scenario, the controller may deactivate non-essential components or scale back high-intensity processes to reduce the burden on the system. By managing load in this manner, the system continues to support communication, relay activation, and other functions required to coordinate distributed resources.

The predictive logic used by the controller incorporates both environmental data and the identified operating mode of the system. For example, the controller may recognize that an electric vehicle and a photovoltaic inverter are active simultaneously, increasing overall demand. By combining this information with temperature data, the controller develops a near-term forecast of expected power requirements and compares the forecast against available standby capacity.

Based on this forecast, the controller prioritizes primary pathways. Communication between the electric vehicle supply equipment and the vehicle may be preserved even if other subsystems are temporarily deactivated. Similarly, the controller may assign higher priority to relays that establish power transfer paths, while placing lower priority on tasks such as visual indicators or background processes.

This architecture therefore combines hardware elements of a home energy system with a control strategy that adapts to changing conditions. The particular sequence of heater modulation, non-critical load reduction, and predictive prioritization supports sustained operation of a home energy system across both cold and hot environments.

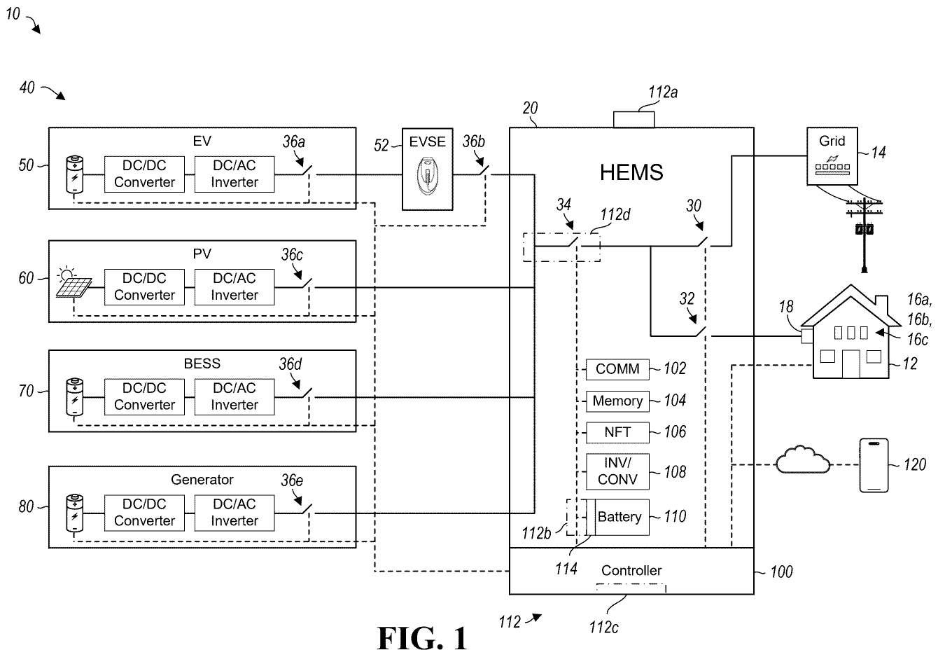

FIG. 1 illustrates an example home energy system 10 configured to manage power distribution across various sources and loads. The system 10 includes a home 12 coupled to an electric power grid 14, as well as multiple distributed energy resources (DERs) 40 connected via a home energy management system (HEMS) 20. Power may be delivered to home loads 16a, 16b, and 16c from the grid 14, from one or more DERs 40, or in some cases from both concurrently. Power flow coordination, source prioritization, and selective isolation or activation of components may be governed by control logic within the HEMS 20.

Grid 14 is coupled to the HEMS 20 through a grid-side switch 30. Similarly, home loads 16a-16c are coupled to HEMS 20 through a load-side switch 32. These switches allow for system-level transition between grid-connected and grid-disconnected modes, and may further support full or partial isolation of the home 12 or downstream components. One or more additional load-side switches may be included to facilitate selective control over individual loads or load groups.

The grid-side switch 30 may be a main breaker that serves as a primary disconnect device, permitting selective isolation of the home 12 from the grid 14. When closed, the grid-side switch 30 allows grid-supplied power to flow to loads, DERs, or storage elements within the system. During a grid outage or selected periods of off-grid operation, the grid-side switch 30 may be opened to facilitate disconnection from the grid 14, such as to prevent backfeed or enable islanded functionality.

The load-side switch 32 may be configured to control the connection between the HEMS 20 and the loads 16a-16c of the home 12. When closed, the load-side switch 32 permits energy flow from the grid 14 or from one or more DERs 40 to the loads 16a-16c. In certain scenarios, such as load prioritization or grid-disconnected operation, the load-side switch 32 may be opened to selectively shed one or more loads or to reallocate available energy. In some embodiments, the load-side switch 32 may include multiple independently controllable relays, enabling granular control of different load segments within the home 12.

The system 10 further includes a home bus 18 that serves as an electrical distribution node interconnecting the HEMS 20 with downstream components of the home 12. The home bus 18 represents the conductive pathway by which power received from the grid 14 or one or more DERs 40 is delivered to the home 12. Loads 16a-16c, as well as other devices or subsystems that may act as sinks or sources of electrical energy, may be coupled to the home bus 18. In various embodiments, the home bus 18 may include parallel conductors for L1, L2, and neutral, or may encompass alternative wiring arrangements suitable for local electrical standards.

The DER interface 34 facilitates electrical and logical coupling between the HEMS 20 and the distributed energy resources 40. In some embodiments, the DER interface 34 may be implemented as a shared bus, physical interconnect, or power distribution panel that allows the HEMS 20 to route power to and from individual DERs. The DER interface 34 may also support monitoring and coordination functions, including relay control, inverter interaction, and data exchange via associated communication links. Each DER 40 may be coupled to the DER interface 34 through a respective switch 36a-36e, permitting the HEMS 20 to selectively connect, disconnect, or manage power flow to or from specific DERs.

The HEMS 20 acts as a central node for routing and coordinating energy between the grid 14, the home 12, and the connected DERs 40. The DERs 40 may include a variety of power-producing or power-storing components, each selectively coupled to the HEMS 20 through the DER interface 34.

In the illustrated embodiment, the DERs 40 include an electric vehicle (EV) 50 connected through electric vehicle supply equipment (EVSE) 52, a photovoltaic (PV) system 60, a battery energy storage system (BESS) 70, and a generator 80. Each DER 40 is electrically coupled to the DER interface 34 and includes a respective switch 36a-36e for connection control.

Switches 36a-36e correspond to the electric vehicle 50, the EVSE 52, the PV system 60, the BESS 70, and the generator 80, respectively. While each of these DERs is connected via the common DER interface 34, the system architecture allows for each DER to be monitored and actuated individually. In some embodiments, the HEMS 20 may selectively operate one or more of these switches based on real-time status, preconfigured logic, or DER-based commands.

The EV 50 and EVSE 52 collectively support bidirectional power flow and dynamic coordination with the HEMS 20. The EV 50 includes an onboard energy storage system and may operate in either a grid-following or grid-forming mode depending on system conditions. The EVSE 52 facilitates charging and discharging operations and may include conversion stages, communication links, and interlocks.

In addition to an EV 50, the home energy system 10 may incorporate additional DERs 40 to provide diverse energy inputs and storage capacity. These DERs 40 may include the PV system 60, BESS 70, and generator 80, each selectively coupled to the DER interface 34 through respective switches 36c, 36d, and 36e. These resources may operate concurrently or independently depending on system status, control priorities, and the availability of grid power, as discussed herein.

The PV system 60 operates as a renewable energy source that generates DC power from sunlight via the solar array. The generated DC power is routed through a DC/DC converter, which optimizes the voltage for feeding into the system, before it is converted to AC power by the DC/AC inverter. This AC power is then supplied to the home 12, contributing to the system's overall energy needs. The PV system's operation is integrated with the HEMS 20, which facilitates coordination with other DERs 40 and external grid conditions. During grid-connected operation, the PV system 60 works in sync with grid power to meet the load demands of the home 12, while surplus energy may be fed back to the grid 14 or used to charge the EV 50 or BESS 70.

In the event of a grid outage, the PV system 60 can continue to generate energy, but its ability to interact with the rest of the system 10 depends on the presence of a stable voltage and frequency reference, which may be supplied by a grid-forming inverter. In such cases, the inverter within the PV system 60 adjusts its output to synchronize with the grid-forming reference, enabling continued energy supply. The coordination of PV power with energy storage (via the BESS 70) and the EV 50 provides efficient energy flow and prioritized usage across the various components.

The BESS 70 stores energy for later use, helping to balance power supply and demand across the home energy system 10. The energy stored in the BESS 70 can be charged using power from the grid 14, the EV 50, the PV system 60, or the generator 80. When energy is required, the BESS 70 discharges stored energy through its associated DC/DC converter and DC/AC inverter, making it available for use by home loads 16a-16c or other system components. The BESS 70 is integrated with HEMS 20, which continuously monitors the SOC of the BESS 70.

During grid-connected operation, the BESS 70 works to reduce reliance on the utility grid 14 by managing stored energy for household use and reducing peak demand. In islanded operation, such as during a grid outage, the BESS 70 provides power to the home 12, working in conjunction with the grid-forming inverter to maintain system stability. The BESS 70 also facilitates power-sharing with the EV 50 and PV 60 as needed, either by storing excess energy produced by PV 60 during daylight hours or by discharging stored power to recharge the EV's traction battery 150.

The generator 80 serves as a backup power source for the home 12, providing continued operation when grid power is unavailable. In typical usage, the generator 80 provides AC power to the system 10 during a grid outage, automatically activating through HEMS 20 or other system logic based on the needs of the home 12. The generator's output is managed by the HEMS 20 and/or EV 50, which may, in some scenarios, ensure that it is only used when necessary, such as during high-demand periods or when other DERs (e.g., PV 60 or BESS 70) are unable to provide sufficient power.

Like other DERs 40, the generator 80 interfaces with the HEMS 20 through its own respective switch 36e, allowing for selective connection or disconnection from the system 10 as needed. The generator 80 is used to maintain power to the home 12 in islanded operation, supplementing other energy sources when the grid 14 is down or when available renewable energy from the PV system 60 or stored energy in the BESS 70 is insufficient. It also has the capability to interact with other DERs 40, providing a stable power source when energy flow from other components is limited, thereby maintaining home functionality during extended outages.

The HEMS 20 (also referred to as a “HEMS hub 20” or “combiner box”) operates as an integration and coordination point for external and local energy resources. The HEMS 20 includes various control, sensing, and switching components configured to evaluate electrical conditions and influence system behavior across the home energy system 10. These components may be housed within a shared enclosure, which may be weatherproof, thermally managed, or internally partitioned to separate high-and low-voltage regions. The HEMS 20 includes pass-through or grommeted cable routing for accommodating L1, L2, neutral, and ground conductors, along with low-voltage wiring for battery connections, control signals, and communication lines. Internally, the HEMS 20 may incorporate terminal blocks, busbars, relays, fuses, or printed circuit boards to support interconnection and coordinated operation. In some configurations, the HEMS 20 includes voltage and frequency monitoring circuitry that observes conditions on an AC bus and provides this information to an internal controller 100 for further analysis.

The HEMS 20 includes the controller 100, which manages electrical coordination across the system 10. The controller 100 may initiate control responses based on monitored conditions and predetermined logic, and may influence relays, loads, transformer connectivity, DER engagement, or interactions with the grid 14. The controller 100 includes processing hardware and memory and may be configured to execute software or firmware routines that enable real-time monitoring, threshold comparison, and operational sequencing. In some configurations, the controller 100 may respond autonomously to internal events, while in other cases, it may interact with remote systems or external user inputs to support coordination.

Although the controller 100 is illustrated as integrated within the HEMS 20, in alternative embodiments, the controller 100 may reside elsewhere within the home 12 or may be partially or entirely remote. In such cases, local sensors or actuators may report to a cloud-based platform, which may in turn transmit control commands back to the system 10. The controller 100 may therefore operate as part of a centralized, distributed, or hybrid control architecture, depending on the implementation.

The controller 100 is operatively connected to a communication interface 102, which facilitates bidirectional data exchange with other system components as well as with external systems such as the remote device 120. The communication interface 102 may support one or more wired or wireless protocols (e.g., Ethernet, Wi-Fi, Bluetooth, or cellular) and may be used to retrieve updated control logic, firmware patches, or configuration profiles from remote sources. The interface 102 may also allow monitored system parameters or operating states to be reported to external entities, such as utility operators, cloud dashboards, or mobile applications.

The remote device 120 may be a mobile phone, tablet, computer, home assistant, or dedicated user interface that facilitates interaction with the HEMS 20. In some implementations, the remote device 120 may display status information, receive push alerts, or provide options for the user to view, adjust, or override HEMS settings. The remote device 120 may access the system 10 through a cloud-based platform or through a local network connection. In certain implementations, the remote device 120 may also receive DER SOC data, forecasted solar production, or pending grid event notifications. These interactions may enable users to schedule charging, prioritize critical loads, or configure fallback settings for islanded operation.

The controller 100 includes or is associated with a memory 104 that stores logic routines, control thresholds, action tables, and condition mappings. The memory 104 may be embedded within the controller 100 or may be located remotely and accessed through the communication interface 102. In some cases, the memory 104 may be updated over time to reflect changing usage profiles, system expansions, or firmware revisions. When executed, the stored instructions cause the controller 100 to perform energy management functions including (but not limited to) relay operation, DER engagement, transformer switching, and condition-based coordination across the system 10.

The HEMS 20 further includes the NFT 106, which facilitates 120V operation during off-grid scenarios. The NFT 106 may comprise a center-tapped winding or other structure capable of producing a synthetic neutral reference between L1 and L2. This supports the continued operation of loads that require a neutral connection in the absence of utility service. The NFT 106 may be selectively engaged or disengaged using a relay associated with the transformer. The controller 100 may monitor grid presence, voltage levels, or transformer temperature and activate or isolate the NFT 106 accordingly.

To support local AC energization during grid outages, the HEMS 20 may include an inverter 108 electrically coupled to a reserve energy source, which may be referred to as a standby battery 110 or dark start battery. The inverter 108 may be configured as a grid-forming inverter that supplies an AC voltage and frequency reference onto the system bus, which can be used to initiate or sustain local power delivery. When energized, the inverter 108 may provide the basis for reconnecting grid-following DERs such as the PV system 60 or BESS 70. In this manner, the inverter 108 enables system startup, load support, or DER coordination during periods when grid power is unavailable.

The standby battery 110 provides DC power to energize control circuits or initiate inverter startup when grid voltage is absent. Under normal conditions, the standby battery 110 may remain isolated and only become active during startup routines or after a grid outage has been detected. In addition to supporting controller 100, communication interface 102, and inverter 108, the standby battery 110 may be coupled to a heating element 114 configured to elevate or maintain the battery's operating temperature in cold environments. The presence of the heating element 114 allows the standby battery 110 to deliver consistent startup power across a range of environmental conditions.

The HEMS 20 further includes one or more sensors 112 operatively coupled to the controller 100. In the illustrated embodiment, the sensors 112 comprise several representative types positioned to provide environmental and component-level data. These inputs enable the controller 100 to monitor temperature, voltage, current, and related conditions associated with the HEMS 20 and its connected resources.

An ambient sensor 112a may be positioned within or proximate to the HEMS enclosure to detect surrounding air temperature. A battery sensor 112b may be thermally coupled to the standby battery 110 or positioned adjacent to the heating element 114 to monitor battery temperature during operation. A controller sensor 112c may be associated with the control electronics, such as a printed circuit board near the microcontroller, to detect localized heating of processing components.

One or more line sensors 112d may be associated with the DER interface 34, grid-side switch 30, load-side switch 32, or other switching elements. These line sensors may provide current, voltage, or thermal data corresponding to relay activation, conductor loading, or DER power flows. Collectively, sensors 112a-112d provide environmental and operational inputs that the controller 100 uses to forecast demand, evaluate system state, and determine staged responses such as adjusting duty cycle of the heating element 114, activating or deactivating relays, or temporarily reducing non-essential loads.

The configuration of FIG. 1 therefore illustrates an arrangement in which a standby reserve (standby battery 110) and associated heating element 114 are integrated with a sensor network 112a-112d and predictive control logic. While the illustrated embodiment depicts specific sensor types and placements, the architecture may accommodate additional or alternative sensing devices. For example, sensors may be positioned proximate to communication modules, inverter stages, or load-side circuits depending on desired monitoring granularity.

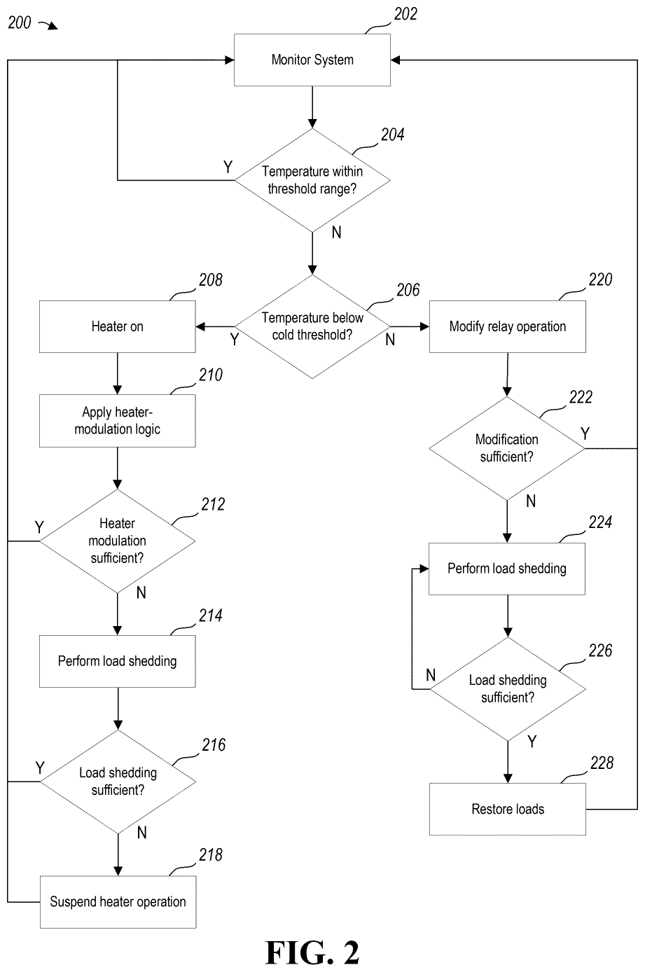

FIG. 2 illustrates an example method 200 for temperature-driven operation of the home energy system 10. The method 200 may be carried out by the controller 100 using inputs from the sensors 112 and outputs directed to the heating element 114, relays, or other components associated with the HEMS 20. Although the method 200 is shown and described in a particular sequence for clarity, certain steps may be performed in a different order, performed concurrently, or omitted depending on implementation.

At step 202, the controller 100 monitors system parameters that provide the basis for subsequent determinations. The monitored values may include inputs from sensors 112a-112d, internal system states, and derived quantities calculated by the controller 100. The sensors 112a-112d provide representative examples of environmental and component-level measurements. The ambient sensor 112a may be positioned within or near the HEMS enclosure to detect surrounding air temperature. The battery sensor 112b may be coupled to the standby battery 110 or positioned proximate to a heating element 114 to monitor local thermal conditions. The controller sensor 112c may detect temperatures within the control electronics, for example at a microcontroller or circuit board location. The line sensors 112d may be positioned to monitor current, voltage, or thermal characteristics of switching elements, such as the grid-side switch 30, load-side switch 32, or DER interface 34.

The controller 100 may further receive information representing system operating states, such as whether the heating element 114 is active, the duty cycle at which it is driven, the presence of an active lockout interval, and the present operating mode of the inverter 108 or NFT 106. Switch positions associated with 30, 32, and 36a-36e may be observed directly or inferred from sensor feedback. Energy availability may be evaluated by monitoring standby battery 110 voltage, estimating its state of charge, and polling the availability of connected DERs 40 including the EV 50, PV system 60, BESS 70, and generator 80.

Sampling may occur continuously or at a periodic cadence, with representative frequencies of 1-10 Hz for temperature values and higher event-based sampling for current surges or relay activity. In some embodiments, monitoring cadence may be reduced when system power is limited, such as when operating solely on the standby battery 110. Sampled values may be time-stamped and conditioned before use, for example by applying averaging filters, range checks, or calibration offsets stored in the memory 104.

During this monitoring stage, the controller 100 may reference stored thresholds and configuration sets retrieved from the memory 104. These may include cold temperature thresholds (e.g., T_cold_on, T_cold_off), hot temperature thresholds (e.g., T_hot_on, T_hot_off), hysteresis bands, heater modulation tables defining duty cycle values at different conditions, load-shedding priority tables ranking non-essential loads, lockout timers, and restore delays. Forecasting parameters, such as continuous windows or trend estimation settings, may also be applied.

Derived quantities may be calculated based on the monitored values. These may include rates of change in temperature for the ambient sensor 112a, battery sensor 112b, and controller sensor 112c, or instantaneous and predicted power margins based on available DER capacity compared to active load. The controller 100 may also apply plausibility checks, such as comparing ambient and controller temperatures for consistency, and may flag degraded channels or initiate fallback routines if implausible or missing data is detected.

In some configurations, the controller 100 logs recent data into a circular buffer or transmits event notifications via the communication interface 102. Logged events may include threshold crossings, heater state changes, or switching activity. Variations may further include use of redundant or external sensors, such as an outdoor temperature input from a thermostat, or distributed sensing performed by sub-modules with results reported to the controller 100. Step 202 therefore establishes a comprehensive baseline of system and environmental conditions that inform subsequent decision points within the method 200.

At step 204, the controller 100 evaluates whether monitored temperature values fall within a predefined threshold range. This determination may be based on one or more of the sensors 112a-112c introduced in FIG. 1. The ambient sensor 112a may provide a reference for surrounding environmental conditions, the battery sensor 112b may provide a thermal reading proximate to the standby battery 110 or associated heating element 114, and the controller sensor 112c may provide an indication of thermal conditions within the control electronics. The controller 100 compares these sensor values to threshold values retrieved from the memory 104.

The threshold range is defined by a lower bound and an upper bound. The lower bound may include a cold-on threshold (T_cold_on) and a cold-off threshold (T_cold_off) to provide hysteresis against rapid cycling. The upper bound may include a hot-on threshold (T_hot_on) and a hot-off threshold (T_hot_off), also with hysteresis. These paired values allow the controller 100 to recognize when the system is stably within the acceptable temperature band, when conditions have fallen below a cold threshold, or when conditions have risen above a hot threshold.

In some embodiments, the controller 100 may evaluate sensor readings against example threshold ranges tailored to different locations within the system. For instance, the ambient sensor 112 a may be referenced to a range of approximately 0° C. to 40° C., reflecting enclosure-level operating conditions, whereas the battery sensor 112b may reference a narrower range, such as 5° C. to 35° C., to preserve battery function. The controller sensor 112 c and line sensors 112d may each reference additional ranges appropriate for electronic boards (e.g., 10° C. to 70° C.) or switching devices. These values are presented as non-limiting examples, and the specific thresholds may vary depending on installation environment, system configuration, or user preferences.

If the determination at step 204 is affirmative, meaning all monitored values lie between the cold-off and hot-off thresholds, the system remains in a normal monitoring state and control returns to step 202. If the determination at step 204 is negative, at least one monitored temperature value lies outside the acceptable band. In such cases, the controller 100 proceeds to step 206, where the out-of-band condition is further evaluated to determine whether it corresponds to a cold condition or a hot condition. A positive determination at step 206 directs the method into the cold-management branch, whereas a negative determination at step 206 indicates that a monitored value has exceeded a hot threshold and directs the method into the hot-management branch.

In some variations, the controller 100 may assign different weightings to the monitored sensors when performing the range evaluation. For example, the battery sensor 112b may be prioritized in the cold condition analysis, while the controller sensor 112c may be prioritized in the hot condition analysis. Additional implementations may incorporate trend analysis, such that an observed downward or upward slope in temperature is factored into the evaluation to anticipate entry into a cold or hot condition. In other configurations, thresholds may be adjusted dynamically based on the operating mode, such as applying more conservative bounds during islanded operation when DER availability is limited.

At step 206, the controller 100 determines whether the monitored temperature values indicate that a cold threshold has been exceeded. This evaluation distinguishes whether the out-of-band condition identified at step 204 corresponds to a cold state or to a hot state. The controller 100 compares the values received from sensors 112a-112c against one or more cold threshold values stored in the memory 104. In particular, the battery sensor 112b provides a reference point for the thermal state of the standby battery 110 or the heating element 114, while the ambient sensor 112a measures surrounding environmental conditions, and the controller sensor 112c provides an indication of temperatures proximate to the control electronics.

Cold thresholds may be defined as paired values, such as a cold-on threshold (T_cold_on) and a cold-off threshold (T_cold_off), to introduce hysteresis and reduce rapid toggling. When the measured temperature falls below the cold-on threshold, a cold condition is identified, while temperatures rising above the cold-off threshold may clear the cold state. Different sensors may be associated with different threshold values, such that the battery sensor 112b is compared against a battery-specific cold threshold, the ambient sensor 112a against an environmental cold threshold, and the controller sensor 112c against an electronics cold threshold. In some configurations, the controller 100 applies conservative logic and enters the cold branch if any monitored channel falls below its assigned threshold. In other configurations, priority may be assigned, such that the battery sensor 112b has precedence over other channels for determining whether heater operation is required.

When the determination at step 206 is affirmative, meaning that one or more monitored values have fallen below a cold threshold, the controller 100 proceeds to step 208 to activate the heating element 114. When the determination at step 206 is negative, the monitored values are not below a cold threshold. In this case, the out-of-band condition identified at step 204 corresponds to a hot state, and the method 200 proceeds to step 220 to adjust switch operation.

By way of example, a cold threshold may be defined such that the heater 114 is activated when the temperature detected by the battery sensor 112b falls below approximately 0-5° C. In other cases, the ambient sensor 112 a may reference a lower threshold, such as −10° C., when the HEMS 20 is mounted outdoors or in unconditioned space. Thresholds may therefore be different for each sensor type, enabling the controller 100 to apply cold-temperature logic selectively to components that require heating while leaving other parts of the system unaffected. These thresholds may be preset at the factory or may be dynamically adjusted based on seasonal conditions, historical usage patterns, or stored configuration profiles.

Alternative implementations may incorporate trend analysis, such that a consistent downward slope in ambient or battery temperature may be treated as an effective cold condition even if the measured value has not yet crossed the cold-on threshold. In further examples, cold thresholds may be adjusted dynamically based on the operating mode of the system 10. For instance, during grid-disconnected operation, lower thresholds may be applied to preserve limited energy reserves, whereas during grid-connected operation, thresholds may be more permissive. Fallback conditions may also be included, such that if a critical temperature channel is marked implausible, the controller 100 may adopt a conservative response and initiate heater activation.

At step 208, the controller 100 activates a heating element 114 when a cold condition has been identified at step 206. The heating element 114 may be thermally coupled to the standby battery 110, positioned within the HEMS enclosure, or otherwise located to provide thermal energy to components that are sensitive to low-temperature operation. The purpose of heater activation is to elevate the monitored temperature values into a predefined operating range that permits reliable energy delivery, control processing, or startup sequencing.

The controller 100 may initiate heater operation by energizing a relay, driver transistor, or other switching device associated with the heating element 114. In some configurations, heater activation begins at full rated power, after which modulation or staged duty cycling may be applied in subsequent steps of the method 200. The heating element 114 may be operated for a minimum duration once activated, such that short-duration cycling is prevented. Termination of heater activity may occur when a monitored temperature rises above a cold-off threshold (T_cold_off), when energy availability is constrained, or when load-shedding routines dictate suspension of heater operation.

Heater activation may rely on energy supplied from different sources depending on system state. When grid power is present, the heating element 114 may be powered directly from the grid 14 through the HEMS 20. In islanded conditions, the heating element 114 may instead be supplied from the standby battery 110, from stored energy in the BESS 70, or from a local DER such as the PV system 60, generator 80, or EV 50 if available. In some embodiments, the controller 100 may prioritize heater operation from DER sources when surplus energy is detected, conserving stored energy in the standby battery 110.

Variations of heater activation may include localized and distributed configurations. For example, a resistive pad heater may be placed directly on the standby battery 110, while a second resistive element may be positioned to warm the internal environment of the HEMS enclosure. In other examples, multiple heating elements may be selectively activated based on which sensor values (112a-112c) have triggered the cold condition determination.

Upon activation of the heating element 114, the controller 100 records the heater state and transitions the method 200 to step 210. At that stage, the controller 100 applies power-management logic to determine whether ongoing heater activity can be maintained without exceeding available capacity or requiring adjustment to other operating conditions.

At step 210, the controller 100 applies power-management logic to control operation of the heating element 114 after activation at step 208. Whereas step 208 represents an initial binary activation of the heater in response to a cold threshold condition, step 210 introduces additional control to balance the thermal demand against available energy supply and overall system priorities. The controller 100 may execute logic routines stored in memory 104 to determine whether the heater 114 should continue to operate at full output, transition to a reduced duty cycle, or be scheduled for suspension depending on the current state of the home energy system 10.

The inputs to this logic may include temperature readings from one or more of the sensors 112. For example, the battery sensor 112b may indicate whether localized heating is progressing toward the desired range, the ambient sensor 112a may identify enclosure-level temperature trends, and the controller sensor 112c may confirm that electronics proximate to the microcontroller remain within an acceptable range. In addition, the controller 100 may evaluate system-level conditions such as the state of charge of the standby battery 110, active contributions from distributed energy resources 40, and the presence or absence of grid 14 power. These measurements may be compared against threshold values and duty-cycle tables stored in the

### Memory 104.

Based on these inputs, the controller 100 may direct the heater 114 to operate at full power, at a reduced duty cycle (e.g., 50% or 25%), or according to a staged activation pattern where initial full power heating is followed by reduced power maintenance. In some cases, the controller 100 may enforce minimum on/off intervals to prevent rapid cycling of the heater 114, or may incorporate time-based profiles that scale heater power in accordance with expected load demands or forecasted DER availability. Forecast-based logic may further project PV production or generator availability to determine whether heater intensity should be sustained or curtailed.

The power-management logic may also incorporate fallback pathways. For example, if available energy is insufficient to sustain even a reduced duty cycle, the method 200 may proceed toward subsequent decisions regarding modulation sufficiency (step 212), load shedding (step 214), or heater suspension (step 218). By distinguishing step 210 from the activation step 208, the method allows the heating element 114 to be transitioned from a simple “on” state to an intelligently controlled state that adapts to dynamic system conditions.

Variations of step 210 may include different prioritization schemes. In some embodiments, when grid power is available, the controller 100 may sustain heater 114 operation at higher levels without limitation. In other embodiments, when the system 10 is operating in an islanded state, heater duty may be scaled back to preserve stored energy in the standby battery 110 or BESS 70. Multiple heating elements 114 may also be individually modulated if present, with each subject to its own duty cycle or staged heating profile. In certain embodiments, cross-component sensing may influence modulation, such as reducing heater duty when the controller sensor 112c reports elevated local temperatures resulting from extended heater operation.

At step 212, the controller 100 determines whether the modulation applied to the heating element 114 at step 210 is sufficient to maintain system balance. This determination evaluates whether the duty-cycle control, staged activation, or other power-management measures have produced adequate heating while remaining within the available energy margin. The inputs to this evaluation may include sensor feedback, energy availability data, and internal state information recorded by the controller 100.

Sensor values may be referenced from the ambient sensor 112a, the battery sensor 112b, and the controller sensor 112c. These inputs indicate whether the standby battery 110 is warming toward its operating range, whether enclosure conditions are trending upward or stable, and whether the electronics remain within acceptable limits. The controller 100 may also consider the present state of charge of the standby battery 110, the contribution of one or more distributed energy resources 40, and the presence of grid 14 supply. These conditions are compared to duty-cycle tables and balance thresholds stored in the memory 104.

In some implementations, the controller 100 may evaluate sufficiency by checking whether the heating element 114, when operated at its reduced duty cycle, is trending toward clearing the cold-on threshold within a defined period. In other examples, sufficiency may be measured by whether the current draw of the heater 114, combined with concurrent loads, remains below a target margin calculated from standby battery 110 capacity or DER availability. Forecast routines may also be applied, for example to recognize that incoming PV production is expected to offset heater demand, in which case modulation may be deemed sufficient even if present values show limited margin.

If the determination at step 212 is affirmative, the heater 114 continues operation under the current modulation strategy, and the controller 100 returns to the monitoring state of step 202 while maintaining the adjusted duty cycle. If the determination is negative, meaning that modulation alone is insufficient to preserve energy balance or to achieve the desired heating trajectory, the method 200 proceeds to step 214 to initiate load-shedding routines. In this way, step 212 functions as a decision gate between power-aware modulation of heater activity and more direct reallocation of system resources.

If the outcome of step 212 indicates that modulation alone is insufficient to sustain continued operation of the heating element 114, the method 200 advances to step 214, in which the controller 100 initiates load shedding to reduce energy demand elsewhere in the system 10. In this stage, the controller 100 references one or more priority tables or condition mappings stored in the memory 104, which may classify the home loads 16a-16c into categories such as critical, intermediate, and non-essential. Based on these classifications, the controller 100 issues commands to the load-side switch 32 or to individual relay branches thereof, selectively disconnecting one or more non-essential loads from the home bus 18.

Load shedding may be performed at varying levels of granularity. In some embodiments, the controller 100 may disconnect an entire group of loads through a common relay, while in other cases the controller 100 may control individual load circuits independently. In certain implementations, shedding is staged or tiered, beginning with the lowest-priority load and then reassessing system stability before moving to additional disconnections. Intermediate delays may be incorporated between successive shedding actions, enabling the controller 100 to evaluate the resulting power margin after each change.

Throughout this process, the controller 100 monitors system response using feedback from the line sensors 112d and other measurement inputs. These sensors may provide real-time data on current, voltage, and relay states, allowing the controller 100 to determine whether heater 114 operation can now be sustained under the applied modulation of step 210. If the newly available margin is sufficient, the heater 114 may continue operating while the system 10 resumes monitoring in step 202.

If, however, the available energy margin remains inadequate even after the targeted loads have been disconnected, the method 200 progresses to step 218, at which heater operation may be suspended. In some cases, this escalation occurs after all non-essential loads have been shed, while in other cases a threshold condition, such as a persistent undervoltage or low SOC condition, may prompt earlier suspension.

The specific implementation of load shedding may vary depending on whether the system 10 is grid-connected or islanded. For example, when grid power is available, load shedding may be limited or bypassed since heater operation can be maintained by drawing from the grid 14. In islanded operation, load shedding may be performed more aggressively to preserve stored energy from the BESS 70, EV 50, or generator 80. Loads subject to shedding may include deferred appliances, discretionary circuits, or secondary DER charging tasks such as vehicle charging. In some variations, the priority classifications may be updated dynamically, for instance based on user preferences, forecasted PV production, or external utility control commands.

Following the execution of step 214, the method 200 advances to step 216, where the controller 100 determines whether the load shedding actions have provided a sufficient energy margin to sustain continued operation of the heating element 114. At this stage, the controller 100 evaluates real-time data received from the sensors 112, including current and voltage measurements from line sensors 112d, thermal feedback from battery sensor 112b, and status information from the DERs 40 and associated relays. These inputs allow the controller 100 to assess whether the disconnection of non-essential loads has effectively reduced demand to a level that supports heater operation without inducing further imbalance.

In some embodiments, this determination involves comparing present system conditions to predefined thresholds stored in the memory 104. For example, the controller 100 may reference minimum bus voltage values, acceptable SOC ranges for the BESS 70 or EV 50, or maximum current draw permitted under the active operating mode. The relay states associated with load-side switch 32 may also be reviewed to confirm that one or more targeted load circuits have been disconnected in accordance with the programmed priority tables.

If the evaluation indicates that the energy margin is adequate, the heater 114 continues operating, and the system 10 returns to step 202 to resume environmental monitoring. In this case, no further escalation is required, and the heater 114 may remain energized under continued modulation logic from step 210. If, however, the evaluation indicates that the margin remains insufficient, the method 200 advances to step 218, where heater operation may be suspended until conditions are more favorable.

In certain variations, load shedding may be implemented in stages rather than all at once. In such cases, step 216 may be repeated iteratively, with the controller 100 reassessing system stability after each additional shedding action. Alternatively, the controller 100 may perform a single evaluation after all non-essential loads have been disconnected, providing a binary determination at step 216. The logic applied in this step may also vary depending on whether the system 10 is grid-connected or operating in islanded mode. For instance, when grid power is available, the adequacy check may be less restrictive, whereas in islanded operation the threshold conditions may be more conservative to conserve stored energy resources.

If the outcome of step 216 indicates that load shedding is insufficient to maintain heater operation, the method 200 advances to step 218, in which the controller 100 suspends operation of the heating element 114. At this stage, the controller 100 issues a command to deactivate the heater relay or to otherwise remove electrical power from the heater 114, thereby preventing continued draw of current that could destabilize the home energy system 10. The decision to suspend is informed by inputs confirming inadequate system margin, such as undervoltage detected by line sensors 112d, SOC values of the BESS 70 or EV 50 falling below predetermined thresholds, or current levels exceeding programmed limits.

In some embodiments, the suspension action is accompanied by the creation of a data record stored in the memory 104, capturing the condition that prompted deactivation and the state of connected loads and DERs 40 at that moment. This record may be useful for later analysis by the controller 100 or by external supervisory systems communicating through interface 102.

Suspension of the heater 114 may be temporary, with the method 200 looping back to step 202 to resume monitoring of environmental and system conditions. If temperatures remain below the cold threshold and adequate margin is later restored through resource recovery, recharging, or reduced demand, heater activation may again be attempted in accordance with the sequence beginning at step 206. To prevent rapid cycling of the heater 114, some configurations incorporate time delays or hysteresis bands, such that reactivation only occurs after a minimum elapsed period or when sensor readings move sufficiently above the suspension threshold.

In certain variations, suspension may take the form of partial reduction rather than complete shutdown. For example, the controller 100 may reduce the heater 114 to a baseline power level that maintains limited thermal input while preserving available energy for higher-priority operations. In other cases, suspension is absolute, with the heater 114 fully disconnected until conditions warrant reactivation.

Regardless of the implementation, step 218 represents the point at which the system 10 prioritizes preservation of power balance and continuation of essential functions over ongoing heater activity. Once suspension is enacted, the method 200 returns to monitoring at step 202, establishing a closed-loop process that continuously reevaluates whether heater operation can be resumed.

If the determination at step 206 indicates that the monitored temperature has exceeded an upper threshold, the method 200 proceeds to step 220, where the controller 100 adjusts switch operation in an effort to reduce thermal strain on the home energy system 10. In illustrative implementations, hot thresholds may be set between approximately 60° C. and 80° C. for electronics such as a printed circuit board or controller sensor 112 c, or between approximately 90° C. and 100° C. for relay contacts or busbars monitored by line sensors 112 d. When these thresholds are exceeded, the controller 100 may reduce stress on the overheated component by cycling a relay, reassigning load to a different conductor, or temporarily suspending non-critical operation. If the adjustment restores the monitored temperature below the threshold range, normal operation continues; otherwise, the logic proceeds to further load-shedding steps. As with the cold thresholds, the hot thresholds may be adjusted or tuned according to component ratings, installation conditions, or user-defined limits.

At step 220, the controller 100 issues commands to the load-side switch 32 or to sub-relays associated with individual circuits, selectively modifying the connectivity of one or more loads 16a-16c. These adjustments may include cycling off discretionary circuits, reducing current draw from non-critical appliances, or temporarily suspending activities that contribute significantly to heating.

In some implementations, the adjustments may also extend to distributed energy resources 40. For example, the controller 100 may reduce or pause charging current to the EV 50 through EVSE 52, curtail power output from the PV system 60, or limit generator 80 contribution if such operation is determined to elevate system temperatures. These changes can be applied individually or in combination, depending on the specific operating context and available resources.

The controller 100 evaluates sensor feedback during this stage, referencing environmental sensor 112a, line sensors 112d, and other monitoring devices to confirm the effect of the adjustments. Historical and forecast data stored in the memory 104 may also guide selection of which switches are reconfigured first. For example, adjustments may prioritize reducing loads that have minimal user effect or are historically associated with higher thermal contribution.

This step is intended as a first-tier corrective action, less disruptive than the full load shedding actions of step 224. In certain embodiments, the controller 100 applies adjustments incrementally, pausing after each change to reassess system state before proceeding further. In other embodiments, a predetermined set of switch adjustments is enacted simultaneously, followed by evaluation at step 222. The extent of adjustments may also vary depending on whether the system 10 is operating in grid-connected or islanded mode, with grid-connected operation favoring DER curtailment and islanded operation biasing toward household load cycling.

Following the relay adjustments of step 220, the method 200 advances to step 222, where the controller 100 determines whether the modifications are sufficient to maintain stable operation under elevated temperature conditions. At this stage, the controller 100 analyzes sensor data received from the environmental sensor 112a, line sensors 112d, and other monitoring devices to evaluate whether system temperature has decreased or stabilized within an acceptable margin. The controller 100 may further consider SOC data from the BESS 70 or EV 50, as well as inverter or generator operating parameters, to confirm that the system 10 remains capable of supporting ongoing load demand without further escalation.

In one implementation, the controller 100 compares the updated conditions against predefined thresholds stored in the memory 104. These thresholds may include an upper allowable ambient temperature, minimum operating voltage levels, or maximum allowable current through individual circuits. The relay states associated with the load-side switch 32 are also reviewed to confirm that the intended modifications were properly executed.

If the evaluation indicates that the relay modifications were sufficient, the method 200 returns to step 202 to resume monitoring, and no further corrective measures are required at that time. If, however, the evaluation indicates that thermal stress remains above the acceptable threshold or that operating margins continue to be inadequate, the method 200 proceeds to step 224, in which the controller 100 escalates to formal load shedding operations.

In certain embodiments, the sufficiency determination at step 222 may be iterative. The controller 100 may implement staged modifications, reassessing system state after each incremental change, until stability is achieved or the escalation condition is met. In other embodiments, the sufficiency determination may occur after a single pass of multiple adjustments, providing a binary result before escalation. The logic applied at this step may also vary depending on the operating state of the system 10. For example, in grid-connected operation, the sufficiency check may be less restrictive since supplemental support is available from the grid 14, whereas in islanded operation, the sufficiency criteria may be stricter to preserve local reserves and protect against cascading instability.

If the determination at step 222 indicates that relay modifications were insufficient to stabilize system operation under elevated temperature conditions, the method 200 advances to step 224, where the controller 100 performs load shedding to reduce energy demand and mitigate further heating. At this stage, the controller 100 references priority tables stored in the memory 104 to identify non-essential loads or secondary functions that may be disconnected without disrupting critical household operation. The controller 100 then issues commands to the load-side switch 32 or to individual sub-relays, selectively removing identified circuits from the home bus 18.

The specific loads subject to shedding may vary depending on system configuration and operating mode. For example, the controller 100 may disconnect discretionary household appliances such as laundry machines, dishwashers, or climate-control auxiliaries that contribute to thermal loading. In other implementations, the controller 100 may suspend charging activity for the EV 50 or BESS 70 if these operations are deemed non-essential under high-temperature conditions. In certain cases, a distributed energy resource such as the generator 80 may also be curtailed or disconnected if its operation contributes to local heating or excessive current draw.

Load shedding at step 224 may be implemented in either a staged or single-pass manner. In staged implementations, the controller 100 disconnects one or more low-priority loads, then reassesses system conditions before proceeding to additional shedding actions. In single-pass implementations, all non-essential loads defined by the active priority table are shed in one operation before the evaluation at step 226. This flexibility enables the system 10 to balance responsiveness with operational continuity.

Sensor feedback from the environmental sensor 112a and line sensors 112d is monitored throughout the shedding process to confirm the resulting changes in system temperature, current draw, and voltage stability. The outcome of these measurements determines whether the actions taken at step 224 were adequate to restore system balance. If so, the method 200 returns to monitoring at step 202. If not, further escalation occurs at step 226, where the sufficiency of load shedding is formally evaluated before additional control actions are initiated.

The criteria applied at this stage may differ depending on whether the home energy system 10 is operating in grid-connected or islanded mode. When grid power is present, load shedding may prioritize DER curtailment over household circuits, since the grid 14 provides supplemental support. In islanded operation, load shedding may focus more directly on household loads to preserve limited stored energy in the BESS 70 or EV 50.

Following the load shedding actions of step 224, the method 200 advances to step 226, where the controller 100 determines whether the resulting reduction in demand has been sufficient to stabilize operation under elevated temperature conditions. At this stage, the controller 100 evaluates updated sensor data from the environmental sensor 112a and line sensors 112d to determine whether system temperature has decreased or stabilized within an acceptable margin, and whether voltage and current values have returned to operating ranges defined in the memory 104. The controller 100 may also consider state-of-charge data from the BESS 70 or EV 50, along with updated operating parameters from the PV system 60 and generator 80, to verify that the home energy system 10 remains capable of meeting essential load requirements without continued overheating.

If the evaluation indicates that the shedding of non-essential loads was sufficient to alleviate thermal stress, the method 200 returns to step 202, where environmental monitoring resumes. In this case, the controller 100 maintains the current set of disconnections until conditions become more favorable, or until the next monitoring cycle determines that previously shed loads may be suitably reconnected.

If, however, the evaluation indicates that conditions remain above the acceptable hot threshold despite load shedding, additional corrective measures may be undertaken. In this regard, the evaluation of step 226 may be performed repeatedly, such that if the initial shedding actions are deemed insufficient, the method loops back to step 224 for further load reduction. This iterative sequence continues until either (i) the controller 100 determines that conditions have returned to an acceptable range, or (ii) all eligible loads have been shed and no additional disconnections remain. In the latter case, the system may hold in a reduced-power state while continuing to monitor at step 202, foregoing restoration until future measurements confirm adequate stability.

The determination at step 226 may be conducted in different ways depending on implementation. In some embodiments, sufficiency is evaluated iteratively after staged shedding of load groups, with the controller 100 reassessing conditions after each incremental adjustment. In other embodiments, all non-essential loads defined by the active priority tables are shed in a single pass, followed by a binary sufficiency check at step 226. The thresholds applied in this evaluation may also vary depending on whether the home energy system 10 is operating in grid-connected or islanded mode. For instance, in grid-connected operation, the sufficiency determination may be more permissive, since supplemental support from the grid 14 is available. In islanded operation, the determination may apply stricter thresholds to conserve stored energy resources.

If the determination of step 226 indicates that the load shedding actions have been sufficient, the method 200 proceeds to step 228, in which previously disconnected loads are restored. In some embodiments, the restoration may be carried out in a staged or tiered fashion, beginning with loads that were most recently shed and progressing toward loads of lower priority or those requiring higher surge currents. The controller 100 may reference a restoration sequence stored in memory 104, which records the order of disconnection and corresponding priorities. After each stage of restoration, the controller 100 may re-evaluate system parameters (including temperatures reported by sensors 112a and 112d and electrical values across the DER interface 34) to verify that conditions remain within the acceptable threshold range established at step 204. In this manner, the system 10 prevents reintroducing instability or overheating while resuming normal operation.

The restoration process may also be subject to programmed dwell times or staggered delays, such that each load is returned incrementally and the system is given time to settle before another load is reconnected. In some embodiments, restoration order may differ from the shedding order, for example by prioritizing user-critical appliances or DER charging circuits that are needed for long-term stability. Alternative implementations may employ adaptive restoration logic, wherein the controller 100 dynamically calculates how much capacity margin is available and restores a load of corresponding size. Restoration may also be influenced by user input received through remote device 120, by time-of-day rules, or by broader coordination with grid signals or DER dispatch commands.

If conditions once again exceed hot thresholds during the restoration sequence, the controller 100 may immediately suspend restoration and revert to a prior shedding state, repeating steps 224-226 until sufficient stability is re-established. Otherwise, once restoration is complete, the method returns to step 202 to continue monitoring under normal operation.

As described above with reference to FIG. 2, method 200 provides a general control framework for managing operation of the home energy system 10 under varying environmental conditions. That method includes steps for monitoring ambient and component temperatures, determining whether such conditions fall within defined thresholds, and responding accordingly. In particular, method 200 contemplates cold-temperature operation, in which the standby battery heater 114 may be activated and managed, as well as hot-temperature operation, in which corrective actions such as relay modification or load shedding may be implemented.

When the method of FIG. 2 progresses along the cold-temperature branch, the outcome frequently includes activation of the standby battery heater 114 to maintain the temperature of the standby battery 110. Once heater operation is underway, the system may encounter additional operational events beyond the initial thermal management response. For example, a user may request activation of an appliance, an automated schedule may initiate a cycle of the EVSE 52, or another subsystem may request power delivery through the home bus 18. Such requests arise at a time when the heater 114 is already consuming power, which introduces additional considerations for system coordination.

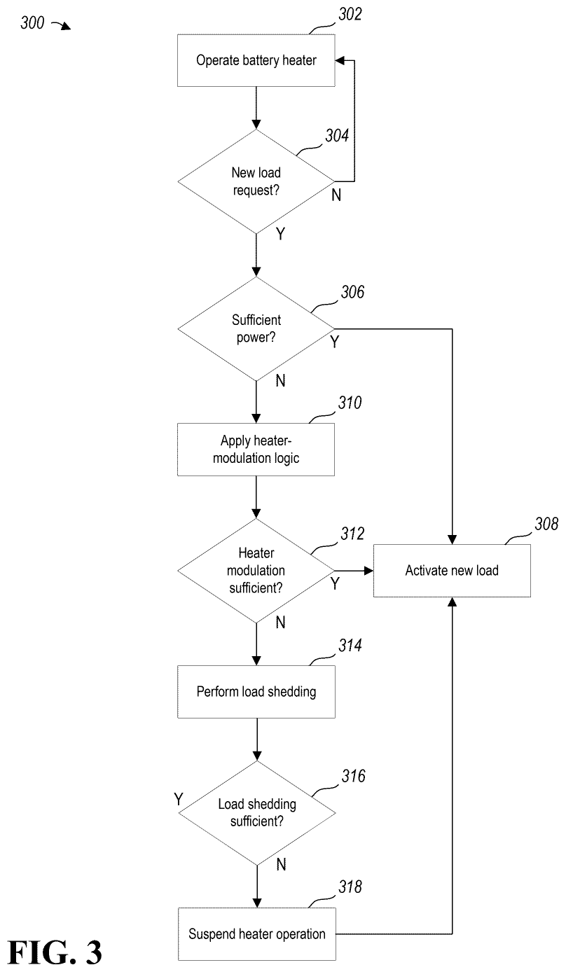

Method 300 of FIG. 3 illustrates a representative control sequence for handling these circumstances. This method is directed to cold-weather operation during which the standby battery heater 114 is already active, and a new load request is received. Unlike the broader framework of method 200, method 300 does not re-determine whether heater activation is warranted. Instead, it presumes that condition has already been satisfied, and focuses on how the system allocates capacity between the ongoing heater draw and the requested load. The sequence includes heater-modulation logic, selective load shedding, and potential suspension of heater operation, with each branch ultimately converging on activation of the new load once sufficient margin is available.

At step 302, the system 10 operates the standby battery heater 114 in response to cold ambient conditions. The controller 100 initiates and sustains heater operation based on temperature inputs received from the sensors 112, including the ambient sensor 112a and the battery sensor 112b. During this step, the heater 114 may operate at a baseline duty cycle, such as a fixed percentage of rated output, or according to preconfigured modulation profiles. The operation of the heater at this stage maintains the battery 110 within a temperature range suitable for continued system responsiveness, without yet considering concurrent requests from other loads.

At step 304, the controller 100 determines whether a new load request has been issued. Such requests may originate from user-initiated actions (e.g., turning on an appliance), scheduled events (e.g., time-based operation of an HVAC component), or autonomous processes (e.g., EVSE 52 initiating a charge cycle). A positive outcome at this decision point indicates that the system must evaluate whether available power is sufficient to authorize activation of the requested load. A negative outcome results in continued heater operation at step 302 until a new request is detected.

At step 306, the controller 100 evaluates whether sufficient power is available to accommodate the new load request while maintaining heater operation. The evaluation may incorporate inputs from line sensors 112 d positioned within the DER interface 34 and switches 30, 32, as well as stored power budgets or predictive models of expected load demand. For example, the controller may compare the aggregate draw of existing loads 16a-16c, heater 114 consumption, and forecasted demand from DERs 40 against a capacity threshold. If the calculated margin exceeds the expected demand of the requested load, the system determines that sufficient power is available.

If sufficient power is available, the method proceeds to step 308. At this stage, the controller 100 authorizes activation of the new load, and power delivery to that load is initiated. The term “activate” as used herein encompasses both permitting a load to begin drawing current and formally connecting the load to the home bus 18 via the appropriate relay or switch. The heater 114 continues operating at its normal level during this process, and no modification or shedding measures are required. From this step, method 300 returns to step 302 to maintain heater operation and continue monitoring for subsequent load requests.

If step 306 determines that insufficient power margin is available, the method proceeds to step 310. At this stage, the controller 100 applies heater-modulation logic to reduce the energy consumed by the standby battery heater 114. This may be achieved by decreasing the duty cycle of a pulse width modulation (PWM) control signal, lowering voltage supplied to the heater, or otherwise scaling its output. The purpose of this step is to preserve partial heating of the battery 110 while releasing capacity for the requested load. Inputs from the ambient sensor 112a and battery sensor 112b may confirm whether heater operation at reduced levels remains within acceptable bounds.

At step 312, the controller 100 determines whether the reduction in heater consumption achieved through step 310 has provided sufficient margin for the new load request. This determination may involve recalculating aggregate system demand and comparing it against power availability from the grid 14 and connected DERs 40. If the modulation is deemed sufficient, the method advances to step 308, at which the new load is activated. If not, the controller escalates to further corrective actions at step 314.

If modulation is insufficient, the method advances to step 314. At this step, the controller 100 performs load shedding by selectively disconnecting or reducing one or more non-essential loads 16a-16c or auxiliary subsystems coupled to the home bus 18. Such operations may be executed using the load-side switch 32, which may incorporate multiple independently controllable relays, or by altering connections through the DER interface 34. Loads considered non-essential may include, for example, lighting circuits, entertainment electronics, or other discretionary power sinks. In some embodiments, load shedding may further include curtailing certain DER operations, such as pausing EV charging through EVSE 52 or reducing inverter activity in the PV system 60.

At step 316, the controller 100 evaluates whether the load shedding actions performed at step 314 have created sufficient margin to accommodate the requested load. The determination may incorporate real-time feedback from line sensors 112d, which provide data regarding current flow, voltage levels, and circuit activity after shedding actions are implemented. If sufficiency is achieved, the system advances to step 308 to activate the new load. If not, the controller initiates suspension of heater operation at step 318.

If insufficient margin remains after load shedding, the method proceeds to step 318. Here, the controller 100 suspends operation of the standby battery heater 114 in order to release all available capacity to the new load. The suspension may be temporary, with environmental and battery sensors 112a and 112b continuing to monitor system conditions while the heater is offline. Once the heater is suspended, the method advances to step 308, where the new load is activated. In this configuration, heater operation may resume once overall demand decreases or when system capacity is restored, such as following disconnection of the new load or reconnection of grid supply.

The two branches of method 300 (namely, the sufficient-power branch (steps 302-308) and the insufficient-power branch (steps 310-318)) ultimately converge at step 308. When step 306 determines that sufficient power is available, the controller 100 may proceed directly to step 308 to activate the requested load while maintaining heater operation at its baseline level. When step 306 determines that power is insufficient, the method advances through corrective measures such as heater modulation (step 310), load shedding (step 314), or heater suspension (step 318). In each case, once adequate margin is established, the controller 100 authorizes activation of the new load at step 308. This converging structure reflects that load activation occurs only after sufficiency has been confirmed, either by initial conditions or by corrective adjustment.

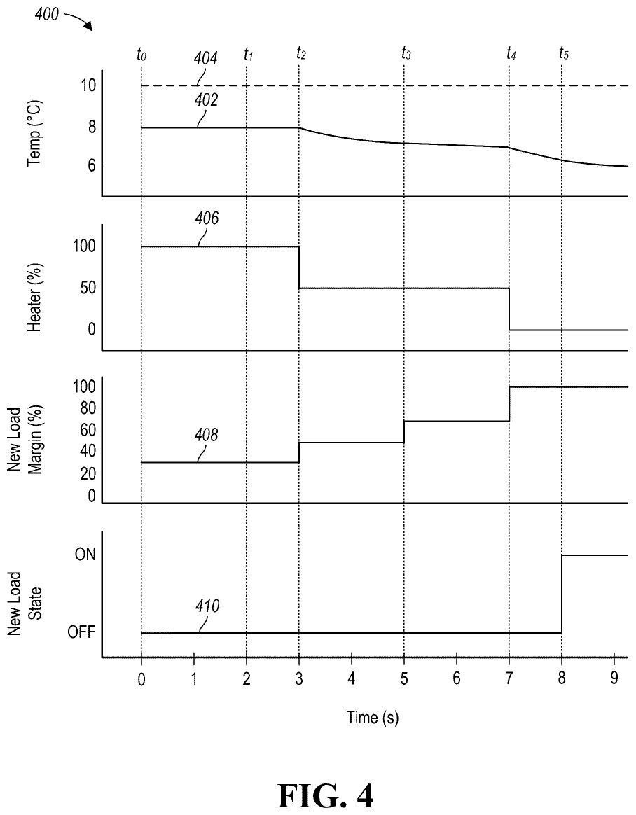

FIG. 4 illustrates representative operational traces of the home energy system 10 during cold-weather conditions, corresponding to the method 300 described above. The figure depicts four concurrent traces aligned along a common time axis. These traces reflect controller operation as it manages battery heating power and system margin in response to a new load request, progressing through stages t0-t5. The figure therefore demonstrates how temperature, heater duty, margin availability, and load state interact as the controller executes the logic of method 300.

The upper trace 402 corresponds to measured battery temperature, shown relative to a cold threshold line 404. In this example, the cold threshold 404 represents the minimum temperature level for sustained battery performance. The battery temperature trace 402 depicts the monitored thermal state of the battery as heater operation is adjusted over time. In one representative configuration, the cold threshold 404 may correspond to a battery temperature of approximately 10° C. The actual battery temperature 402 is shown in the illustrated trace at approximately 5° C., thereby remaining below the cold threshold throughout the scenario. The heater operation therefore may function to prevent further decline in thermal state rather than to raise the temperature above the threshold line.

The second trace 406 represents battery heater duty cycle, expressed as a percentage of available output power. Variations in this trace correspond to controller-directed modulation of the heater to balance heating requirements against new load availability.

The third trace 408 depicts system margin, shown as a normalized percentage. A reference line (e.g., at 100%) indicates the sufficiency threshold required before a new load can be activated.

The lower trace 410 represents the binary activation state of the requested load, where the trace remains low while the load is inactive and transitions high upon activation.

At time t0, corresponding to step 302 of method 300, the system operates in a baseline state. The heater power 406 is applied at full duty cycle to maintain battery temperature 402 near the cold threshold 404. System margin 408 is stable. No new load is pending; accordingly, the load state 410 remains OFF.

At time t1, corresponding to step 304, a new load request is received. The battery heater 406 continues to operate at its prior duty cycle, and battery temperature 402 remains stable. However, the load state 410 remains OFF because margin 408 has not reached the threshold required for activation. In the illustrated example, the system margin 408 is approximately 30% of the new load support. This illustrates that, without intervention, available headroom is insufficient to support the requested load. The battery heater 406 remains at full duty (100%) at this stage, and the battery temperature 404 remains stable at approximately 5° C.

At time t2, corresponding to step 310, the controller applies power-management logic by modulating heater duty. The heater trace 406 decreases from full duty (e.g., 100%) to a reduced value (e.g., 50%). This modulation produces a corresponding increase in system margin 408, which rises closer to the sufficiency line (e.g., 100%) (e.g., from ˜30% to ˜50%). The battery temperature 402 begins to drift slightly downward, reflecting reduced thermal input, settling at approximately 5° C. The load state 410 remains OFF at this stage.

At time t3, corresponding to step 314, the controller performs load shedding of non-essential components. The margin trace 408 rises further as available capacity is reallocated (for example from ˜50% to ˜70%), while heater duty 406 remains at the reduced level (e.g., approximately 50%). The battery temperature 402 continues to show a gradual decline, again reflecting reduced heater input. The load state 410 remains OFF, pending further margin recovery.

At time t4, corresponding to step 318, the controller suspends battery heater operation. The heater trace 406 falls from the reduced state (e.g., 50%) to zero. This action restores margin 408 to at or above the 100% sufficiency line, meeting the threshold for load activation. Battery temperature 402 shows gradual decline within the cold region, staying proximate to the cold threshold 404. The load state 410 remains OFF but is now poised for transition.

At time t5, corresponding to step 308, the controller activates the new load. This transition is visible as the load state trace 410 moves from OFF to ON. At this point, margin 408 is sufficient (e.g., 100%), heater operation 406 is suspended, and battery temperature 402, while reduced, remains within acceptable range relative to the cold threshold 404.

The configurations described above present an example home energy system 10 in which environmental sensing, controller logic, and distributed energy resources are integrated to manage operation under varying temperature conditions. Although particular thresholds, parameters, and sequencing examples have been described, these are intended to illustrate representative operating states rather than to define specific limitations. For instance, cold thresholds may be higher or lower depending on battery chemistry, heater duty cycles may be modulated in variable increments, and margin sufficiency may be expressed in different normalized or absolute scales. Similarly, while the examples show heater modulation followed by load shedding and heater suspension, alternative sequencing or parallel operations may be implemented depending on control priorities.

The system architecture also provides flexibility with respect to DER participation, sensor placement, and controller implementation. Additional DERs beyond those shown may be coupled through the interface 34, and sensing arrangements may incorporate other device-level monitors in addition to or in place of those illustrated in FIG. 1. The controller 100 may execute locally within the HEMS hub 20, remotely in a distributed platform, or in hybrid arrangements where certain determinations are made locally while broader coordination is performed through cloud interaction.

The algorithms, methods, and processes described herein may be executed by or delivered to a controller, processor, or other computing device associated with the home energy system 10 or with one or more distributed energy resources. Such computing devices may include dedicated electronic control units, programmable electronic controllers, or general-purpose processors configured with appropriate software instructions. The disclosed logic may be stored as instructions or data in various non-transitory computer-readable media, including read-only memory, random access memory, flash devices, magnetic media, optical media, or other storage forms. Execution of such instructions may occur entirely in software, partially in software with firmware assistance, or in whole or in part using dedicated hardware such as application-specific integrated circuits, programmable logic devices, or state machines. In some implementations, control routines may be distributed across multiple hardware layers, such as a local HEMS controller 100 in communication with cloud-based servers, with processing responsibility apportioned between local and remote resources.

The embodiments described above are provided for illustration rather than limitation, and are not intended to encompass all variations falling within the scope of the appended claims. The terminology used herein is selected for purposes of clarity of description and should not be construed as restrictive. It should be understood that modifications may be made to the disclosed structures, steps, and sequences without departing from the broader concepts conveyed. For example, while particular temperature thresholds, duty cycles, or sequencing orders have been described, alternative values, gradations, or prioritization logic may be implemented depending on the context of use.

As indicated above, the features of different embodiments may be used in combination or in modified form to generate additional implementations not expressly illustrated. Although certain embodiments may be described in relation to their suitability for addressing specific operational conditions, such as cold-weather operation with heater modulation or hot-weather operation with load shedding, those skilled in the art will recognize that compromises or substitutions may be made among characteristics to achieve overall system objectives. These attributes may relate, for example, to efficiency of control, responsiveness to transients, coordination with grid conditions, computational complexity, or integration with existing infrastructure. Thus, embodiments described as less favorable with respect to one characteristic may nonetheless be advantageous in other contexts, and remain within the scope of this disclosure.

What is claimed is:

1. A home energy system comprising:
a controller;
a standby battery configured to energize the controller during a grid loss condition; and
a heating element;
the controller configured to:
when a sensed temperature is below a cold threshold, operate the heating element to apply thermal energy to the standby battery and, upon a new load request, adjust power to the heating element to reduce active load demand; and
when the sensed temperature is above a hot threshold, adjust a state of a controllable switch to reduce active load demand.

2. The home energy system of claim 1, wherein the controller is configured to adjust power to the heating element by adjusting a pulse-width modulation duty cycle.

3. The home energy system of claim 1, wherein the controller is configured to cease operation of the heating element to further reduce active load demand.

4. The home energy system of claim 1, wherein adjusting the state of the controllable switch comprises disconnecting at least one load from the home energy system.

5. The home energy system of claim 4, wherein the controller is further configured to reconnect the at least one load after the sensed temperature falls below the hot threshold.

6. The home energy system of claim 1, wherein the hot threshold corresponds to a sensed temperature within a range of about 40° C. to about 60° C.

7. The home energy system of claim 1, wherein the controller is configured to adjust the state of the controllable switch to reduce active load demand when the new load request is received during a temperature condition above the hot threshold.

8. The home energy system of claim 1, wherein the standby battery is further configured to supply power to an inverter that establishes an alternating-current reference for the system during a grid loss condition.

9. The home energy system of claim 8, wherein the inverter is within electric vehicle supply equipment (EVSE) coupled to the system.

10. The home energy system of claim 9, wherein the EVSE is further configured to activate relays of an electric vehicle to enable bidirectional power flow between the electric vehicle and the home energy system during the grid loss condition.

11. A controller for a home energy system, comprising processing hardware and memory storing instructions that, when executed, cause the controller to:
when a temperature sensed at a standby battery is below a cold threshold, activate a heating element thermally coupled to the standby battery;
upon a new load request while the temperature remains below the cold threshold, adjust power applied to the heating element to preserve margin for a new load; and
when the margin remains insufficient after the adjustment, suspend operation of the heating element to allow activation of the new load.

12. The controller of claim 11, wherein adjusting power applied to the heating element comprises varying a pulse-width modulation duty cycle.

13. The controller of claim 11, wherein the controller is further configured to resume operation of the heating element when a margin for the new load is restored.

14. The controller of claim 11, wherein the cold threshold corresponds to a sensed temperature within a range of about 0° C. to about 15° C.

15. The controller of claim 11, wherein the temperature is sensed by a sensor positioned proximate to the standby battery.

16. A method of operating a home energy system including a controller, a standby battery, and a heating element thermally coupled to the standby battery, the method comprising:
during a temperature condition below a cold threshold at the standby battery, operating the heating element at a power level;
upon a new load request while the temperature condition persists, the new load request exceeding an available system capacity:
reducing a power level of the heating element to increase the available system capacity;
when the available system capacity remains less than the new load request with the heating element operating at the reduced power level, disconnecting a home load to increase the available system capacity; and
when the available system capacity remains less than the new load request with the home load disconnected, suspending operation of the heating element to increase the available system capacity; and
upon achieving sufficient available system capacity, activating a new load associated with the new load request.

17. The method of claim 16, wherein reducing the power level of the heating element comprises modifying a pulse width modulation duty cycle of the heating element.

18. The method of claim 16, further comprising forecasting the available system capacity based on environmental sensor data and operational status of at least one distributed energy resource selected from a photovoltaic inverter, a battery energy storage system inverter, or an electric vehicle inverter.

19. The method of claim 16, wherein suspending operation of the heating element comprises deactivating the heating element for a predetermined time interval and subsequently reactivating the heating element when the available system capacity increases.

20. The method of claim 16, wherein the standby battery is further configured to supply power to electric vehicle supply equipment during the temperature condition, and wherein the new load request is from the electric vehicle supply equipment in communication with a coupled electric vehicle.
